(19) United States
(12) Patent Application Publication
(10) Pub. No.: US 2009/0176105 A1
(43) Pub. Date: Jul. 9, 2009

(54) Thermal insulation paper

(76) Inventor: Kuo-Hsiung Tsai, Gueishan Township (TW)

Correspondence Address: TROXELL LAW OFFICE PLLC, SUITE 1404, 5205 LEESBURG PIKE, FALLS CHURCH, VA, 22041, US

(21) Appl. No.: 12/068,647

(22) Filed: Feb. 8, 2008

(30) Foreign Application Priority Data
Feb. 14, 2007 (TW) 096202830

(51) Int. Cl. B32B 27/36

(52) U.S. Cl. 428/422; 428/483; 428/473.5; 428/458

(57) ABSTRACT

A thermal insulation paper includes a plastic layer, a thermal insulation layer covered on one side of the plastic layer, and a thin-film layer covered on an opposite side of the thermal insulation layer opposite to the plastic layer and having a plurality of spots of glue located on one side opposite to the thermal insulation layer for adhering to a surface.

### BACKGROUND OF THE INVENTION

1. Field of the Invention

The present invention relates to thermal insulation papers and more particularly, to such a thermal insulation paper that facilitates installation, and is reusable.

2. Description of the Related Art

The window or windshield glass of a car or the window glass of a building may be covered with a layer of thermal insulation paper to isolate the radiation of sunlight. FIG. 1 illustrates a conventional thermal insulation paper for this purpose. As illustrated, the thermal insulation paper comprises a thin film (multi-layer film) 100, a thermal insulation layer 110, an adhesive layer 120, and a strippable layer 130. The adhesive layer 120 is prepared from an adhesive for adhering to a glass. The adhesive can be pure adhesive, or the mixture of an adhesive and a thermal insulation material. During application, the glass is well cleaned, and then the strippable layer 130 is detached from the adhesive layer 120, and then the glass and the adhesive layer 120 is sprayed with water, and then the adhesive layer 120 of the thermal insulation paper is attached to the glass, and then a rule or scraper is used to smoothen the thermal insulation paper.

The aforesaid thermal insulation paper is still not satisfactory in function because of the following drawbacks.
1. Applying the thermal insulation paper to a glass requires a special technique, and only a killed person can work, thereby increasing the application cost.
2. If water molecules between the adhesive layer 120 and the surface of the glass are not completely expelled, the thermal insulation paper will wrinkle. In this case, the thermal insulation paper must be detached from glass and then adhered to the glass against.

Therefore, it is desirable to provide a thermal insulation paper that eliminates the aforesaid drawbacks.

### SUMMARY OF THE INVENTION

The present invention has been accomplished under the circumstances in view. It is the main object of the present invention to provide a thermal insulation paper, which facilitates installation. It is another object of the present invention to provide a thermal insulation paper, which is reusable.

To achieve these and other objects of the present invention, the thermal insulation paper comprises a plastic layer, a thin-film layer, and a thermal insulation layer sandwiched between the plastic layer and the thin-film layer. The thin-film layer has a plurality of spots of glue located on its one side opposite to the thermal insulation layer for adhering to a surface.

### BRIEF DESCRIPTION OF THE DRAWINGS

FIG. 1 is a schematic drawing showing the structure of a thermal insulation paper according to the prior art.

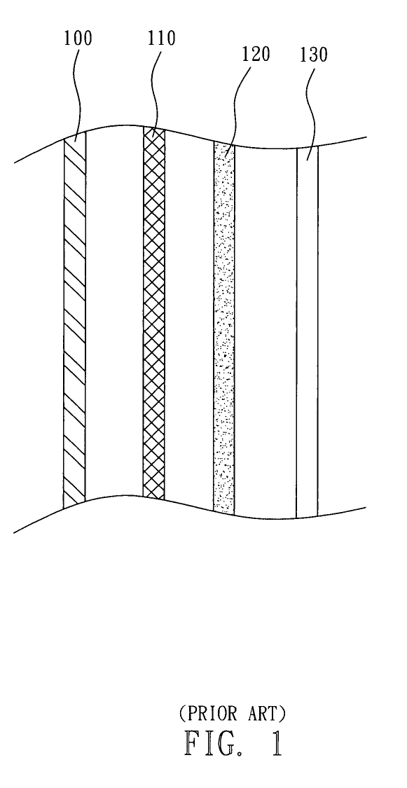

FIG. 2 is a schematic drawing showing the structure of a thermal insulation paper according to a first embodiment of the present invention.

FIG. 3 is a schematic drawing showing the structure of a thermal insulation paper according to a second embodiment of the present invention.

FIG. 4 is a schematic drawing showing the structure of a thermal insulation paper according to a third embodiment of the present invention.

FIG. 5 is a schematic drawing showing the structure of a thermal insulation paper according to a fourth embodiment of the present invention.

### DETAILED DESCRIPTION OF THE PREFERRED EMBODIMENT

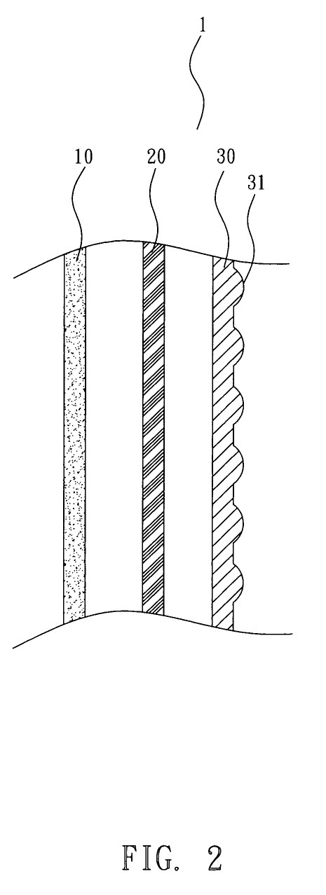

Referring to FIG. 2, a thermal insulation paper 1 in accordance with a first embodiment of the present invention is shown comprised of a plastic layer 10, a thermal insulation layer 20, and a thin-film layer 30. The thermal insulation layer 20 is sandwiched between the plastic layer 10 and the thin-film layer 30.

The plastic layer 10 is a thin layer of high-strength plastics, for example, PET (polyethylene terephthalate) that isolates sunlight.

The thermal insulation layer 20 is covered on the plastic layer 10. It can be a metal coating, for example, aluminum coating coated on the surface of the plastic layer 10 to isolate the reflection of sunlight. Alternatively, the thermal insulation layer 20 can be formed of a thin layer of thermal insulation material, such as nanometered ATO (arsenic trioxide) or LaB₆ (lanthanum hexaboride).

The thin-film layer 30 is covered on one side of the thermal insulation layer 20 opposite to the plastic layer 10, having multiple spots of glue 31 for adhering to a surface, preferably a flat surface, for example, the surface of a window or windshield glass of a car or a window glass of a building. The thin-film layer 30 can be prepared from, but not limited to, PET (polyethylene terephthalate), PVC (polyvinyl chloride), nylon, PI (polyimide), or teflon. The spots of glue 31 can be regularly or irregularly arranged on the thin-film layer 30 to show a specific pattern. The spots of glue 31 can be prepared from acrylic rubber, silicon glue, polyurethane glue, or rubber glue. Further, the material for the spots of glue 31 may be added with organic or inorganic thermal insulation additives.

During application, wipe the surface of the window or windshield glass of the car or the window glass of the building clean, and then spray water over the cleaned surface of the window or windshield glass and the surface of the thin-film layer 30 of the thermal insulation paper 1 to facilitate position adjustment of the thermal insulation paper 1 after the thermal insulation paper 1 has been attached to the surface of the window or windshield glass, and then smoothen the thermal insulation paper 1 with a flat member, for example, a rule or scraper to expel water molecules away from the gap between the thin-film layer 30 and the window or windshield glass. The aforesaid water spraying procedure may be eliminated. In this case, the thin-film layer 30 of the thermal insulation paper 1 is directly attached to the surface of the window or windshield glass, and then a rule or scraper is used to smoothen the thermal insulation paper 1. In case of a mistake during the work, the thermal insulation paper 1 can be directly detached from the window or windshield glass, and then applied to the surface of the glass again. Therefore, the thermal insulation paper 1 of the present invention is reusable.

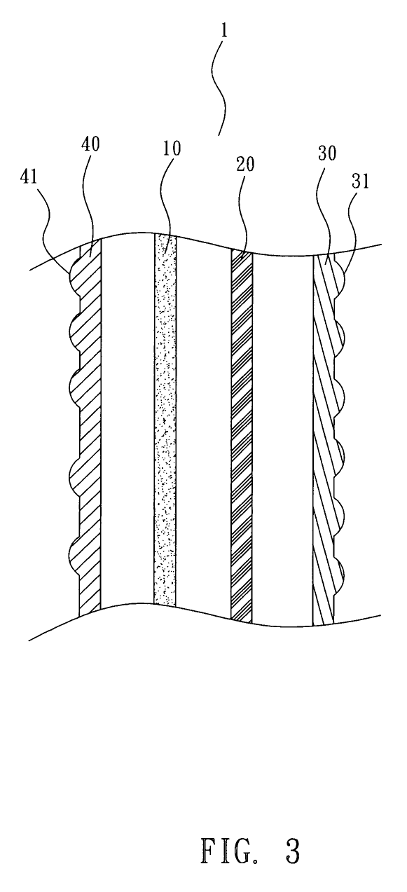

FIG. 3 illustrates a thermal insulation paper 1 in accordance with a second embodiment of the present invention. This embodiment is substantially similar to the aforesaid first embodiment with the exception of an added second thin-film layer 40 that is covered on one side of the plastic layer 10 opposite to the thermal insulation layer 20. The second thin-film layer 40 comprises multiple spots of glue 41 for adhering to a surface, preferably a flat surface. The second thin-film layer 40 can be prepared from, but not limited to, PET (polyethylene terephthalate), PVC (polyvinyl chloride), nylon, PI (polyimide), or teflon. The spots of glue 41 can be regularly or irregularly arranged on the second thin-film layer 40 to show a specific pattern. The spots of glue 41 can be prepared from acrylic rubber, silicon glue, polyurethane glue, or rubber glue. Further, the material for the spots of glue 41 may be added with organic or inorganic thermal insulation additives.

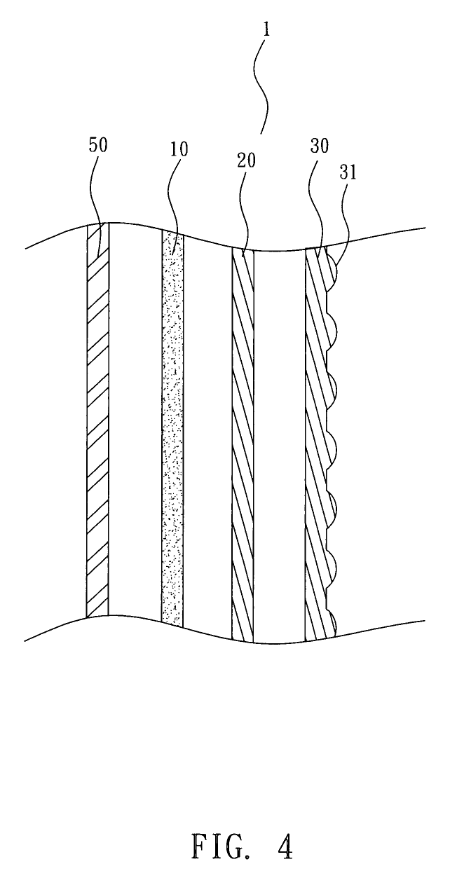

FIG. 4 illustrates a thermal insulation paper 1 in accordance with a third embodiment of the present invention. This embodiment is substantially similar to the aforesaid first embodiment with the exception of an added adhesive layer 50 that is covered on one side of the plastic layer 10 opposite to the thermal insulation layer 20. The adhesive layer 50 can be prepared from a pure adhesive, or added with thermal insulation additives.

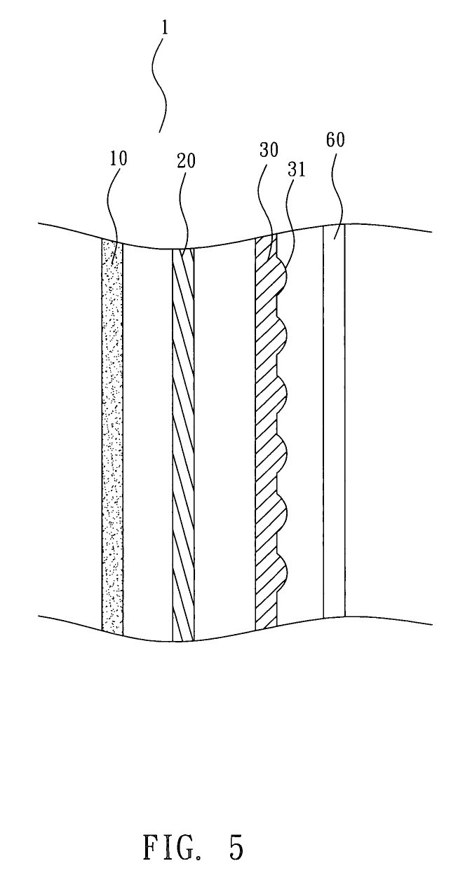

FIG. 5 illustrates a thermal insulation paper 1 in accordance with a fourth embodiment of the present invention. This embodiment is substantially similar to the aforesaid first embodiment with the exception of an added strippable layer 60 that is covered on one side of the thin-film layer 30 opposite to the thermal insulation layer 20 to protect the thin-film layer 30.

As stated above, the invention provides a thermal insulation paper that facilitates application and is reusable.

Although particular embodiments of the invention have been described in detail for purposes of illustration, various modifications and enhancements may be made without departing from the spirit and scope of the invention.

What is claimed is:

1. A thermal insulation paper comprising:
a plastic layer;
a thermal insulation layer covered on one side of said plastic layer; and
a thin-film layer covered on an opposite side of said thermal insulation layer opposite to said plastic layer, said thin-film layer having a plurality of spots of glue located on one side thereof opposite to said thermal insulation layer for adhering to a surface.

2. The thermal insulation paper as claimed in claim 1, wherein said plastic layer is prepared from polyethylene terephthalate and adapted for isolating sunlight.

3. The thermal insulation paper as claimed in claim 1, wherein said thermal insulation layer is a metal coating.

4. The thermal insulation paper as claimed in claim 3, wherein said metal coating is aluminum coating.

5. The thermal insulation paper as claimed in claim 1, wherein said thermal insulation layer is a thin layer of a thermal insulation material.

6. The thermal insulation paper as claimed in claim 5, wherein the thermal insulation material of said thermal insulation layer is ATO (arsenic trioxide).

7. The thermal insulation paper as claimed in claim 5, wherein the thermal insulation material of said thermal insulation layer is LaB₆ (lanthanum hexaboride).

8. The thermal insulation paper as claimed in claim 1, wherein said thin-film layer is prepared from one of the materials of PET (polyethylene terephthalate), PVC (polyvinyl chloride), nylon, PI (polyimide) and teflon; said spots of glue contain a thermal insulation material and are arranged on said thin-film layer to show a predetermined pattern.

9. The thermal insulation paper as claimed in claim 1, further comprising a second thin-film layer prepared from one of the materials of PET (polyethylene terephthalate), PVC (polyvinyl chloride), nylon, PI (polyimide) and Teflon and covered on one side of said plastic layer opposite to said thermal insulation layer, said second thin-film layer having a plurality of spots of glue located on one side thereof opposite to said plastic layer for adhering to a surface.

10. The thermal insulation paper as claimed in claim 9, wherein the spots of glue of said second thin-film layer contain a thermal insulation material and are arranged on said second thin-film layer to show a predetermined pattern.

11. The thermal insulation paper as claimed in claim 1, further comprising an adhesive layer covered on one side of said plastic layer opposite to said thermal insulation layer.

12. The thermal insulation paper as claimed in claim 11, said adhesive layer contains a thermal insulation material.

13. The thermal insulation paper as claimed in claim 1, further comprising a strippable layer covered on one side of said thin-film opposite to said thermal insulation layer.

14. The thermal insulation paper as claimed in claim 13, wherein said thin-film layer is prepared from one of the materials of acrylic rubber, silicon glue, polyurethane glue and rubber glue.
